(19) United States
(12) Patent Application Publication
(10) Pub. No.: US 2024/0414612 A1
(43) Pub. Date: Dec. 12, 2024

(54) CELL RESELECTION METHOD AND USER EQUIPMENT

(71) Applicant: KYOCERA Corporation, Kyoto (JP)

(72) Inventor: Mitsutaka HATA, Yokohama-shi (JP)

(73) Assignee: KYOCERA Corporation, Kyoto (JP)

(21) Appl. No.: 18/798,551

(22) Filed: Aug. 8, 2024

Related U.S. Application Data
(63) Continuation of application No. PCT/JP2023/003785, filed on Feb. 6, 2023.

(30) Foreign Application Priority Data
Feb. 9, 2022 (JP) 2022-019037

(51) Int. Cl. H04W 36/08; H04W 36/00; H04W 60/04

(52) U.S. Cl. CPC H04W 36/08; H04W 36/0061; H04W 60/04

(57) ABSTRACT

In a first aspect, a cell reselection method is performed in a mobile communication system. The cell reselection method includes transmitting, by a base station, mapping information between a first slice group and a second slice group when the second slice group includes at least some of network slices included in the first slice group, the first slice group being available in a region of the base station, and the second slice group being available in a neighboring region adjacent to the region. The cell reselection method includes performing, by a user equipment, slice-specific cell reselection by using the mapping information.

### RELATED APPLICATIONS

The present application is a continuation based on PCT Application No. PCT/JP2023/003785, filed on Feb. 6, 2023, which claims the benefit of Japanese Patent Application No. 2022-019037 filed on Feb. 9, 2022. The content of which is incorporated by reference herein in their entirety.

### TECHNICAL FIELD

The present disclosure relates to a cell reselection method in a mobile communication system.

### BACKGROUND

In specifications of the Third Generation Partnership Project (3GPP), which is a standardization project for mobile communication systems, Network Slicing has been defined (for example, see Non-Patent Document 1). Network slicing is a technique for configuring a network slice that is a virtual network by logically dividing a physical network constructed by a telecommunications carrier.

### CITATION LIST

### Non-Patent Literature

Non-Patent Document 1: 3GPP TS 38.300 V16.8.0 (2021-12)

### SUMMARY

In a first aspect, a cell reselection method is performed in a mobile communication system. The cell reselection method includes transmitting, by a base station, mapping information between a first slice group and a second slice group when the second slice group includes at least some of network slices included in the first slice group, the first slice group being available in a region of the base station, and the second slice group being available in a neighboring region adjacent to the region. The cell reselection method includes performing, by a user equipment, slice-specific cell reselection by using the mapping information.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack for a user plane according to a first embodiment.

FIG. 5 is a diagram illustrating a configuration example of a protocol stack for a control plane according to the first embodiment.

FIG. 6 is a diagram illustrating an overview of a cell reselection procedure.

FIG. 7 is a flowchart illustrating a schematic flow of a typical cell reselection procedure.

FIG. 8 is a diagram illustrating an example of network slicing.

FIG. 9 is a diagram illustrating an overview of a slice-specific cell reselection procedure.

FIG. 10 is a diagram illustrating an example of slice frequency information.

FIG. 11 is a flowchart illustrating a basic flow of the slice-specific cell reselection procedure.

FIG. 12 is a diagram illustrating an example of mapping relationships between slice groups and network slices according to the first embodiment.

FIG. 13 is a diagram illustrating an example of mapping relationships between slice groups and network slices according to the first embodiment.

FIG. 14 is a diagram illustrating an example of mapping relationships between slice groups and network slices according to the first embodiment.

FIG. 15 is a diagram illustrating an example of mapping relationships between slice groups and network slices according to the first embodiment.

FIG. 16 is a flowchart illustrating an operation example according to the first embodiment.

### DESCRIPTION OF EMBODIMENTS

A user equipment in a Radio Resource Control (RRC) idle state or an RRC inactive state performs a cell reselection procedure. In the 3GPP, slice-specific cell reselection that is a network slice-dependent cell reselection procedure is under study.

An aspect aims at cell reselection being appropriately performed by the user equipment. An aspect aims at improving transmission efficiency in a base station. An aspect aims at mitigating a security problem.

A mobile communication system according to an embodiment is described with reference to the drawings. In the description of the drawings, the same or similar parts are denoted by the same or similar reference signs.

### First Embodiment

### Configuration of Mobile Communication System

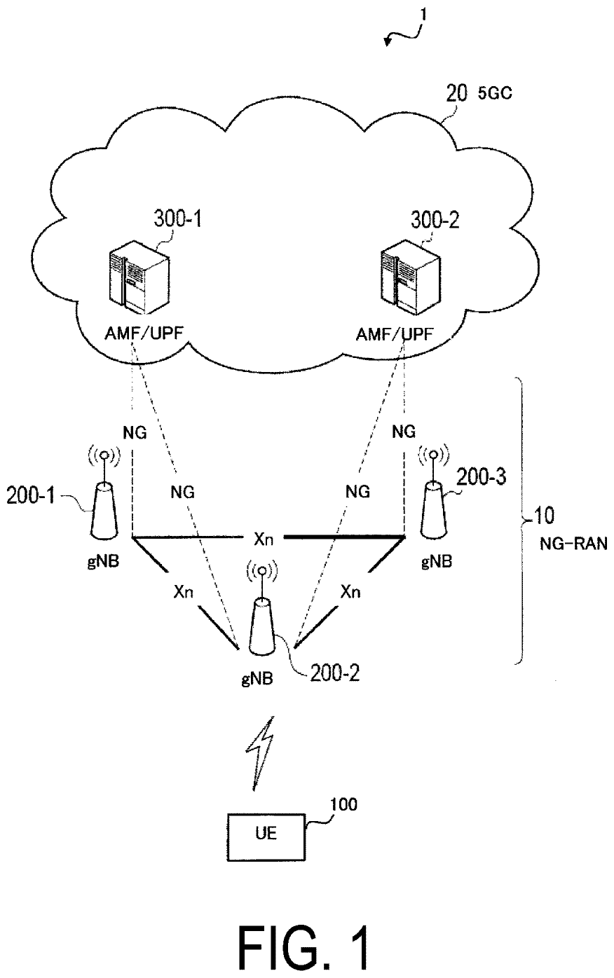

FIG. 1 is a diagram illustrating a configuration of a mobile communication system according to a first embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF 300 performs various types of mobility controls and the like for the UE 100. The AMF 300 manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network.

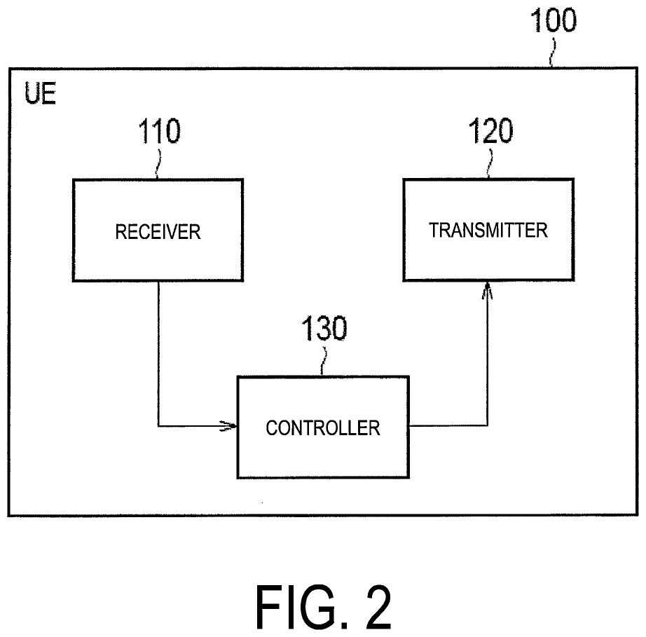

FIG. 2 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

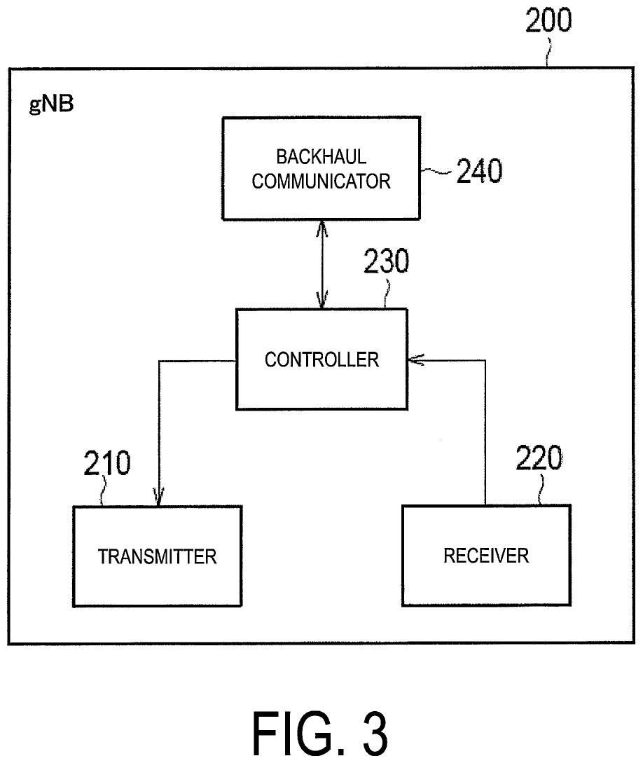

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

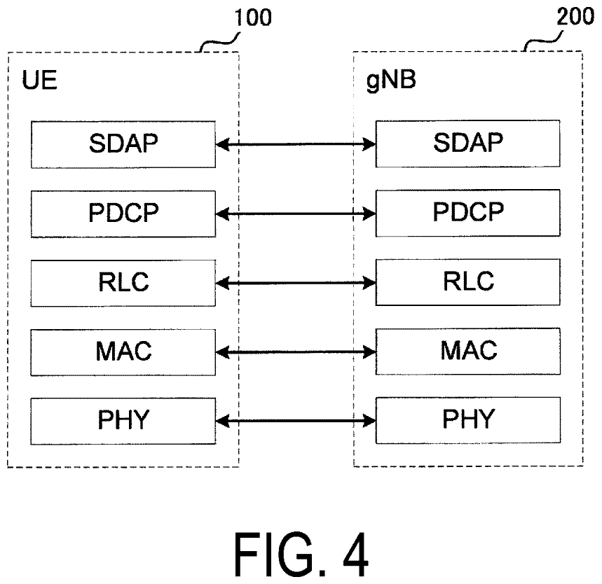

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

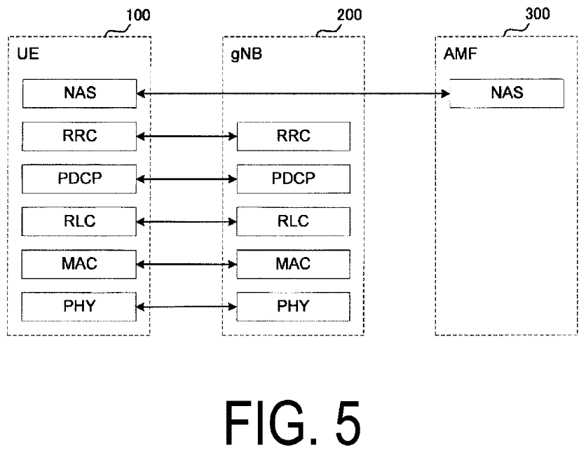

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as Access Stratum (AS).

### Overview of Cell Reselection Procedure

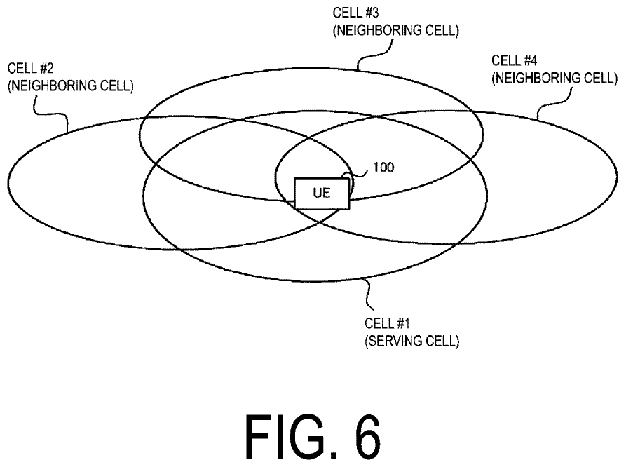

FIG. 6 is a diagram illustrating an overview of a cell reselection procedure.

The UE 100 in the RRC idle state or the RRC inactive state performs the cell reselection procedure with moving to migrate from a current serving cell (cell #1) to a neighboring cell (any one of cells #2 to #4). To be more specific, the UE 100 specifies a neighboring cell to be camped by the UE 100 through the cell reselection procedure and reselects the specified neighboring cell. When the frequency (carrier frequency) is the same between the current serving cell and the neighboring cell, it is referred to as an intra-frequency, and when the frequency (carrier frequency) is different between the current serving cell and the neighboring cell, it is referred to as an inter-frequency. The current serving cell and the neighboring cell may be managed by the same gNB 200. The current serving cell and the neighboring cell may be managed by the gNBs 200 different from each other.

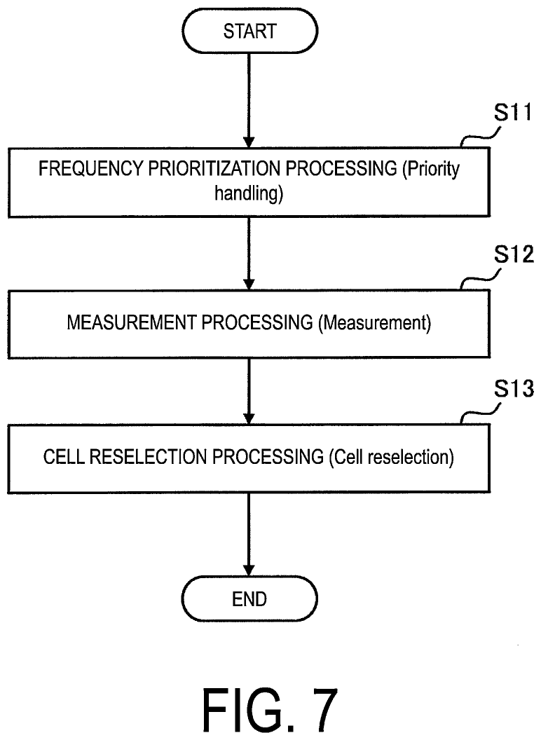

FIG. 7 is a flowchart illustrating a schematic flow of a typical (or legacy) cell reselection procedure.

In step S11, the UE 100 performs frequency priority handling processing based on frequency-specific priorities (also referred to as “absolute priorities”) specified by the gNB 200, for example, by way of a system information block or an RRC release message. To be more specific, the UE 100 manages the frequency priority designated by the gNB 200 for each frequency.

In step S12, the UE 100 performs measurement processing of measuring radio qualities of the serving cell and each of the neighboring cells. The UE 100 measures reception powers and reception qualities of reference signals transmitted by the serving cell and each of the neighboring cells, to be more specific, cell defining-synchronization signal and PBCH block (CD-SSB). For example, the UE 100 always measures the radio quality for frequencies having a higher priority than the frequency of the current serving cell, and for frequencies having a priority equal to or lower than the priority of the frequency of the current serving cell, the UE 100 measures the radio quality of the frequency having the priority equal to or lower than the priority of the frequency of the current serving cell when the radio quality of the current serving cell is below a predetermined quality.

In step S13, the UE 100 performs the cell reselection processing of reselecting a cell on which the UE 100 camps based on the measurement result in step S20. For example, the UE 100 may perform cell reselection to a neighboring cell when a priority of a frequency of the neighboring cell is higher than the priority of the current serving cell and when the neighboring cell satisfies a predetermined quality standard (i.e., a minimal quality standard) for a predetermined period of time. When the priories of the frequencies of the neighboring cells are the same as the priority of the current serving cell, the UE 100 may rank the radio qualities of the neighboring cells to perform cell reselection to the neighboring cell ranked higher than a rank of the current serving cell for a predetermined period of time. When the frequency of the neighboring cell has a lower priority than the frequency of the current serving cell, the radio quality of the current serving cell is lower than a certain threshold value, and the radio quality of the neighboring cell is continuously higher than another threshold value for the predetermined period of time, the UE 100 may perform cell reselection to reselect the neighboring cell.

### Overview of Network Slicing

The network slicing is a technique for virtually dividing a physical network (for example, a network including the NG-RAN 10 and the 5GC 20) constructed by an operator to create a plurality of virtual networks. Each virtual network is referred to as a network slice. Hereinafter, the “network slice” may be simply referred to as a “slice”.

The network slicing allows a communication carrier to create slices according to service requirements of different service types, such as enhanced Mobile Broadband (eMBB), Ultra-Reliable and Low Latency Communications (URLLC), and massive Machine Type Communications (mMTC), for example, to optimize network resources.

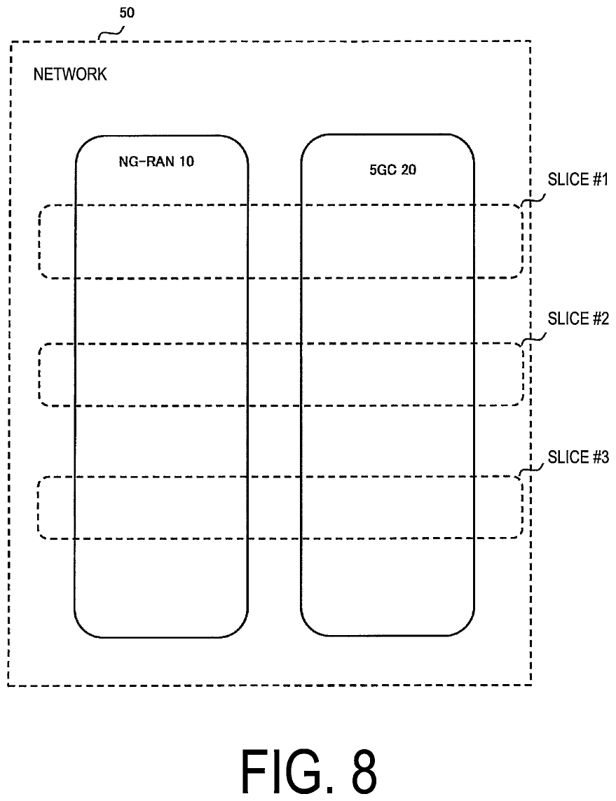

FIG. 8 is a diagram illustrating an example of the network slicing.

Three slices (slices #1 to #3) are configured on a network 50 including the NG-RAN 10 and the 5GC 20. The slice #1 is associated with a service type of eMBB, the slice #2 is associated with a service type of URLLC, and the slice #3 is associated with a service type of mMTC. Note that three or more slices may be configured on the network 50. One service type may be associated with a plurality slices.

Each slice is provided with a slice identifier for identifying the slice. Examples of the slice identifier include a Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a slice is associated. The SD is information for differentiating a plurality of slices associated with the same service type. The information including a plurality of pieces of S-NSSAI is referred to as a Network Slice Selection Assistance Information (NSSAI).

One or more slices may be grouped to configure a slice group. The slice group is a group including one or more slices, and a slice group identifier is assigned to the slice group. The slice group may be configured by the core network (for example, the AMF 300), or may be configured by the radio access network (for example, the gNB 200). The UE 100 may be notified of the configured slice group.

Hereinafter, the term “network slice (slice)” may refer to S-NSSAI that is an identifier of a single slice or NSSAI that is a collection of pieces of S-NSSAI. The term “network slice (slice)” may refer to a slice group that is a group of one or more pieces of S-NSSAI or NSSAI.

The UE 100 also determines an intended slice that the UE 100 desires to use. A desired slice may be referred to as an “intended slice”. In the first embodiment, the UE 100 determines a slice priority for each network slice (desired slice). For example, the NAS of the UE 100 determines the slice priority based on an operation status of an application in the UE 100 and/or a user operation/setting, and notifies the AS of slice priority information indicating the determined slice priority.

### Overview of Slice-Specific Cell Reselection Procedure

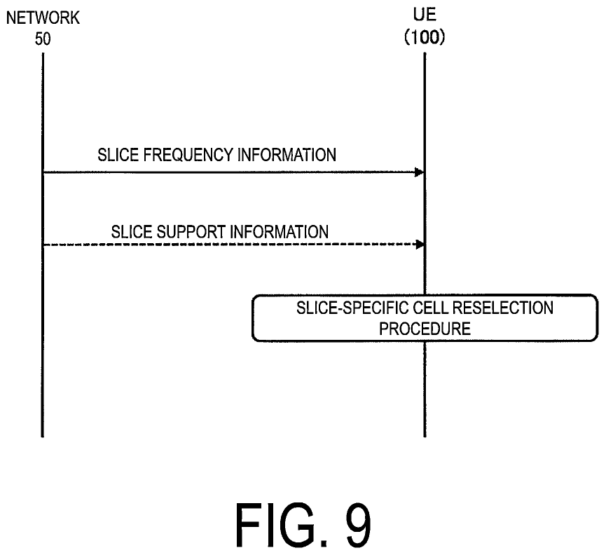

FIG. 9 is a diagram illustrating an overview of a slice-specific cell reselection procedure.

In the slice-specific cell reselection procedure, the UE 100 performs cell reselection processing based on slice frequency information provided from the network 50. The slice frequency information may be provided from the gNB 200 to the UE 100 through broadcast signaling (for example, a system information block) or dedicated signaling (for example, an RRC release message).

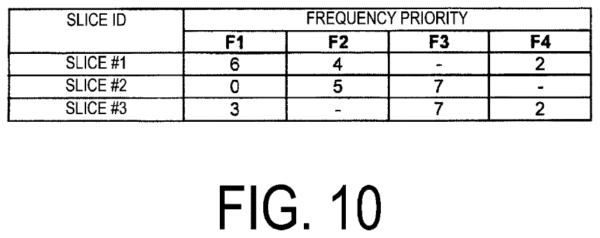

The slice frequency information is information indicating mapping between network slices, frequencies, and frequency priorities. For example, the slice frequency information indicates, for each slice (or slice group), a frequency (one or more frequencies) that supports the slice and a frequency priority assigned to each frequency. FIG. 10 illustrates an example of the slice frequency information.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example of FIG. 10, the larger the number of the frequency priority, the higher the priority is, but a case in which the smaller the number, the higher the priority is may also be possible.

Three frequencies F1, F2, and F3 are associated with the slice #2 as frequencies that support the slice #2. Among these three frequencies, the frequency priority of F1 is “0”, the frequency priority of F2 is “5”, and the frequency priority of F3 is “7”.

Three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice-specific frequency priority” in order to be distinguished from the absolute priority in the conventional cell reselection procedure.

As illustrated in FIG. 9, the UE 100 may perform the cell reselection processing further based on slice support information provided from the network 50. The slice support information may be information indicating mapping between a cell (for example, a serving cell and each neighboring cell) and a network slice that is not provided or provided by the cell. For example, a cell may temporarily fail to provide some or all network slices due to congestion or the like. That is, even for a slice support frequency capable of providing a network slice, some cells within the frequency may not provide the network slice. Based on the slice support information, the UE 100 may grasp which network slice is not provided by each cell. The slice support information like this may be provided from the gNB 200 to the UE 100 through broadcast signaling (for example, a system information block) or dedicated signaling (for example, an RRC release message).

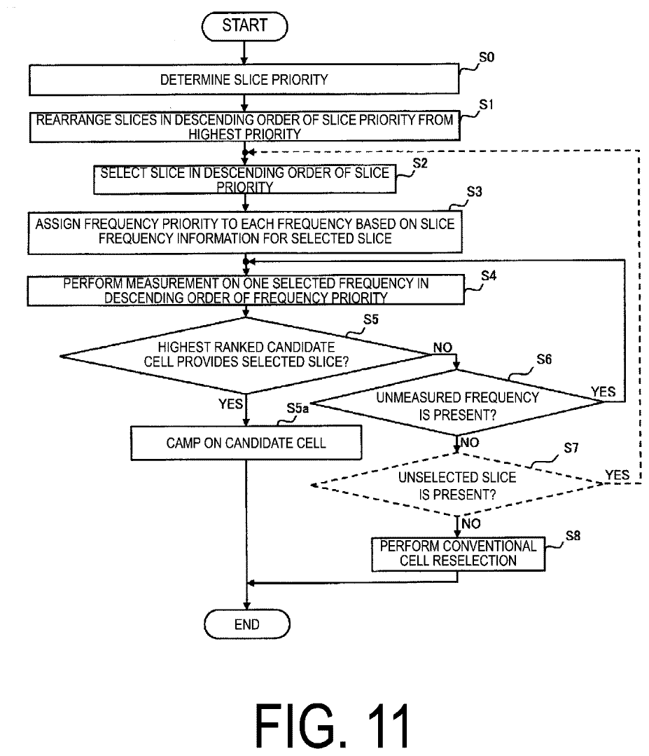

FIG. 11 is a flowchart illustrating a basic flow of the slice-specific cell reselection procedure. Before starting the slice-specific cell reselection procedure, the UE 100 is assumed to be in the RRC idle state or the RRC inactive state, and to receive and retain the above-mentioned slice frequency information. The “slice-specific cell reselection procedure” describes the procedure of the “slice-specific cell reselection”. However, in the following description, the “slice-specific cell reselection” and the “slice-specific cell reselection procedure” may be used with the same meaning.

In step S0, the NAS of UE 100 determines the slice identifiers of the desired slices for the UE 100 and the slice priorities of the desired slices, and notifies the AS of the UE 100 of slice priority information including the determined slice priorities. The “desired slice” is an “Intended slice”, and includes a slice that is likely to be used, a candidate slice, a wanted slice, a slice with which communication is desired, a requested slice, an allowed slice, or an intended slice. For example, the slice priority of the slice #1 is determined to be “3”, the slice priority of the slice #2 is determined to be “2”, and the slice priority of the slice #3 is determined to be “1”. The larger the number of the slice priority, the higher the priority is, but a case in which the smaller the number, the higher the priority is may also be possible.

In step S1, the AS of the UE 100 rearranges the slices (slice identifiers), of which the AS is notified by the NAS in step S0, in descending order of slice priority. A list of the slices arranged in this manner is referred to as a “slice list”.

In step S2, the AS of the UE 100 selects one network slice in descending order of slice priority. The network slice selected in this manner is referred to as a “selected network slice”.

In step S3, the AS of the UE 100 assigns, for the selected network slice, a frequency priority to each of the frequencies associated with that network slice. To be more specific, the AS of the UE 100 specifies frequencies associated with the slice based on the slice frequency information and assigns frequency priorities to the specified frequencies. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 according to the slice frequency information (for example, the information in FIG. 10). The AS of the UE 100 refers to a list of frequencies arranged in descending order of frequency priority as a “frequency list”.

In step S4, the AS of the UE 100 selects one of the frequencies in descending order of frequency priority for the selected network slice selected in step S2, and performs the measurement processing on the selected frequency. The frequency selected in this manner is referred to as a “selected frequency”. The AS of the UE 100 may rank the cells measured within the selected frequency in descending order of radio quality. Among the cells measured within the selected frequency, those cells that satisfy a predetermined quality standard (i.e., a minimal quality standard) are referred to as “candidate cells”.

In step S5, the AS of the UE 100 specifies a highest ranked cell based on the result of the measurement processing in step S4, and determines whether the cell provides the selected network slice based on the slice support information. When determining that the highest ranked cell provides the selected network slice (step S5: YES), the AS of the UE 100 reselects the highest ranked cell and camps on that cell in step S5a.

On the other hand, when determining that the highest ranked cell does not provide the selected network slice (step S5: NO), the AS of UE 100 determines in step S6 whether a frequency not measured is present in the frequency list created in step S3. In other words, the AS of the UE 100 determines whether a frequency to which the frequency priorities have been assigned in step S3 other than the selected frequency is present in the selected network slice. When determining that a frequency not measured is present (step S6: YES), the AS of the UE 100 resumes the processing for the frequency having the next highest frequency priority, and performs the measurement processing by use of that frequency as selected frequency (returns the processing to step S4).

When determining that a frequency not measured is not present in the frequency list created in step S3 (step S6: NO), the AS of the UE 100 may determine in step S7 whether an unselected slice is present in the slice list created in step S1. In other words, the AS of the UE 100 may determine whether a network slice other than the selected network slice is contained in the slice list. When determined that an unselected slice is present (step S7: YES), the AS of the UE 100 resumes the processing for the network slice having the next highest slice priority, and selects that network slice as the selected network slice (returns the processing to step S2). Note that in the basic flow illustrated in FIG. 11, the process in step S7 may be omitted.

When determining that an unselected slice is not present (step S7: NO), the AS of the UE 100 performs conventional cell reselection processing in step S8. The conventional cell reselection processing may mean an entirety of a typical (or legacy) cell reselection procedure illustrated in FIG. 7. The conventional cell reselection processing may also mean only cell reselection processing (step S30) illustrated in FIG. 7. In the latter case, the UE 100 may use the measurement result in step S4 without measuring the radio qualities of the cells again.

Cell Reselection Method according to First Embodiment

As described above, in the slice-specific cell reselection (which may be slice aware cell reselection), the UE 100 selects the desired slice for processing. At this time, the UE 100 may select a slice group as the selected slice. For example, the UE 100 selects a slice group #1 that includes the slice #1, which is the desired slice. In this case, the UE 100 may reselect a cell supporting the corresponding slice group #1 in the slice-specific cell reselection.

The slice group includes one or more network slices. The 3GPP has agreed that slice groups should be homogeneous within the same Registration Area (RA). That is, in the same RA, all the network slices included in a slice group should be the same.

Note that the RA includes one or a plurality of cells, and is defined as a set of Tracking Areas (TAs). Since the RA includes a plurality of TAs, the RA enables a reduction in the number of transmissions of the registration update signaling compared to per TA transmission of the registration update signaling.

On the other hand, in a different RA, the slice group may include different network slices.

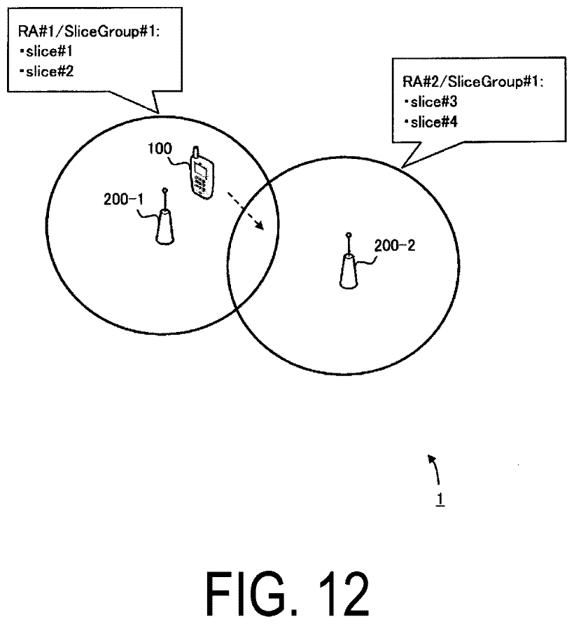

FIG. 12 is a diagram illustrating an example of mapping relationships between slice groups and network slices according to the first embodiment. FIG. 12 illustrates an example in which the boundary between the cell range of a gNB 200-1 and the cell range of a gNB 200-2 is the boundary between RAs. That is, the cell of the gNB 200-1 belongs to an RA #1, and the cell of the gNB 200-2 belongs to an RA #2. The RA #1 including the cell of the gNB 200-1 includes the slice #1 and the slice #2 as the slice group #1. In the RA #2 including the cell of the gNB 200-2, the slice group #1 includes the slice #3 and the slice #4. Between the RA #1 and the RA #2, even the same slice group #1 includes different network slices.

In such an example, the following case is considered. That is, in the RA #1, the UE 100 camps on the cell supporting the slice group #1 by cell reselection according to the slice-specific cell reselection procedure.

Subsequently, the UE 100 moves and performs cell reselection again according to the slice-specific cell reselection procedure. At this time, the UE 100 is assumed to have moved to an area where the UE 100 can communicate with the cell of the gNB 200-2 (that is, the cell of the RA #2). In this case, since the desired slice is the slice #1, the UE 100 may select the slice group #1 in the RA #2 and perform the slice-specific cell reselection procedure. The UE 100 attempts to camp on the cell supporting the slice group #1 in the RA #2.

However, the slice group #1 in the RA #2 does not support the slice #1, which is the desired slice. Therefore, in such a case, selecting, by the UE 100, the slice group #1 in the RA #2 means selecting a wrong cell group. In such a case, the UE 100 performs no appropriate cell reselection.

Thus, such a problem may be solved by using a SIB to broadcast, by the gNB 200, the slice groups supported in the neighboring cell. For example, in the case of FIG. 12, the gNB 200-1 broadcasts identification information of the slice group #1 and identification information of each of the slice #3 and the slice #4 as the information of the slice group #1 supported in the neighboring cell (i.e., the RA #2). Since the UE 100 can recognize the mapping relationship between the slice group #1 and slices (the slice #3 and the slice #4) in the RA #2, the UE 100 can refrain from selecting the slice group #1 in the RA #2 at the time of slice-specific cell reselection.

However, the broadcast of the slice group by the gNB 200 may pose the following problem.

First, 32 bits are present for the identification information of the network slice. The identification information of the network slice has a large data size compared to the information of the slice group, which is simply a number. Accordingly, transmission of the identification information of the network slice by the gNB 200 during transmission of the slice group is not necessarily more efficient than transmission of the identification information of the slice group.

Second, the transmission of the identification information of the network slice by the gNB 200 may pose a problem in terms of security. For example, an operator other than the operator managing the gNB 200 may be able to acquire the identification information of the network slice.

Thus, an object of the first embodiment is to perform appropriate cell reselection in the UE 100. Another object of the first embodiment is to improve the transmission efficiency in the gNB 200. Yet another object of the first embodiment is to mitigate the security problem.

Thus, in the first embodiment, the gNB 200-1 transmits mapping information indicating the mapping relationships between the slice groups in the RA #1 and the slice groups in the RA #2 without transmitting the identification information of the network slice.

Specifically, first, the base station (e.g., the gNB 200-1) transmits the mapping information between a first slice group (e.g., a cell group #1) and a second slice group (e.g., a cell group #2) when the second slice group includes at least some of network slices included in the first slice group, the first slice group being available in a region (e.g., the RA #1) of the base station, and the second slice group being available in a neighboring region (e.g., the RA #2) adjacent to the region. Second, the user equipment (e.g., the UE 100) performs slice-specific cell reselection using the mapping information.

Thus, the UE 100 can acquire information of the slice group including the desired slice in the RA #2 from the mapping information received from the gNB 200-1. Therefore, even upon moving to the boundary between the RAs, the UE 100 can mitigate a wrong selection of a slice group by reselecting a cell supporting the desired slice. Therefore, the UE 100 can perform appropriate cell reselection.

The mapping information includes no identification information of the network slice. Therefore, the transmission of the mapping information can improve the transmission efficiency of the gNB 200 compared with the transmission of the identification information of the network slice. Since the identification information of the network slice is not transmitted, the security problem can be mitigated.

Specific examples of the mapping information include the following.

First, some of the network slices included in a first slice group in a first RA may be included in a second slice group in a second RA.

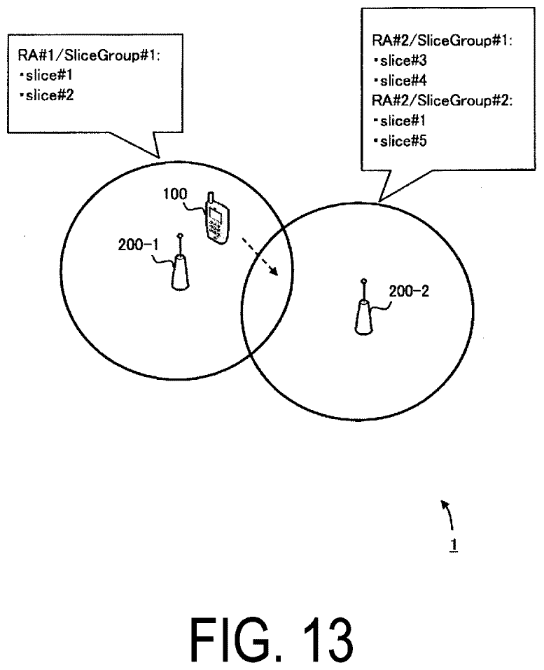

FIG. 13 is a diagram illustrating an example of mapping relationships between slice groups and network slices according to the first embodiment. In FIG. 13, both the slice group #1 in the RA #1 and the slice group #2 in the RA #2 include the same slice #1. Therefore, the slice group #1 in the RA #1 and the slice group #2 in the RA #2 can be mapped as the mapping information. Specifically, the identification information of the RA #1 and the identification information of the slice group #1 may be mapped to each other, the identification information of the RA #2 and the identification information of the slice group #2 may be mapped to each other, and information obtained by mapping these pieces of information may be included in the mapping information. Note that the identification information of the RA may be represented by a list of TAs included in the RA (the list refers to a Tracking Area Identity (TAI) list). The same applies to the description below. Note that the mapping information may include information indicating a “partial match” as a type of mapping information. The mapping information may also include the number of network slices included in each slice group. For example, in the example of FIG. 13, the mapping information may include “2” for the slice group #1 in the RA #1 (the slice #1 and the slice #2) and “2” for the slice group #2 in the RA #2 (the slice #1 and the slice #5).

Second, all of the network slices included in the first slice group in the first RA may be included in the second slice group in the second RA.

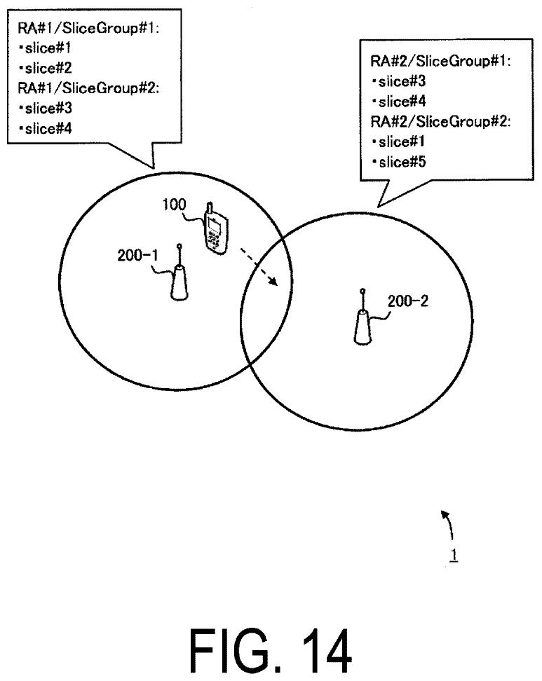

FIG. 14 is a diagram illustrating an example of mapping relationships between slice groups and network slices according to the first embodiment. In FIG. 14, the network slices (the slice #3 and the slice #4) included in the slice group #2 in the RA #1 are all the same as the network slices (the slice #3 and the slice #4) included in the slice group #1 in the RA #2. In this case, in the mapping information, the identification information of the RA #1 and the identification information of the slice group #2 are mapped to each other, the identification information of the RA #2 and the identification information of the slice group #1 are mapped to each other, and information obtained by mapping these pieces of information may be included in the mapping information. Note that the mapping information may include information indicating a “complete match” as a type of mapping information. The mapping information may also include the number of network slices included in each slice group. For example, in the example of FIG. 14, the mapping information includes information indicating “2” for the slice group #2 in the RA #1 (the slice #3 and the slice #4) and “2” for the slice group #1 in the RA #2 (the slice #3 and the slice #4).

Third, one network slice included in the first slice group in the first RA may be the same as one network slice included in the second slice group in the second RA.

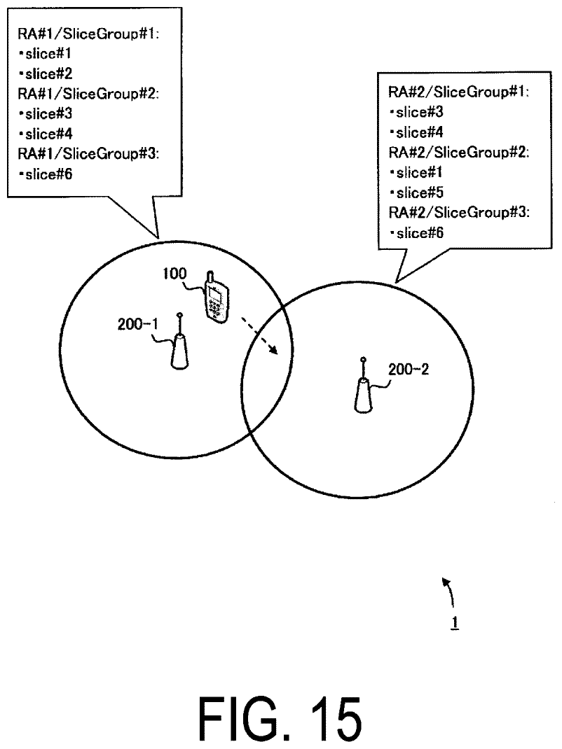

FIG. 15 is a diagram illustrating an example of mapping relationships between slice groups and network slices according to the first embodiment. In FIG. 15, one network slice (the slice #6) included in the slice group #3 in the RA #1 is the same as one network slice (the slice #6) included in the slice group #3 in the RA #2. In this case, in the mapping information, the identification information of the RA #1 and the identification information of the slice group #3 may be mapped to each other, the identification information of the RA #2 and the identification information of the slice group #3 may be mapped to each other, and information obtained by mapping these pieces of information may be included in the mapping information. The mapping information in this case is more effective when one slice group includes only one network slice. Note that the mapping information may include information indicating a “complete match” as a type of mapping information. The mapping information may also include the number of network slices included in the slice group. For example, in the example of FIG. 15, the mapping information may include information indicating “1” for the slice group #3 in the RA #1 (the slice #6) and “1” for the slice group #3 in the RA #2 (the slice #6).

The above three types of mapping information may be combined. In the example shown in FIG. 14, the slice group #1 in the RA #1 and the slice group #2 in the RA #2 may be mapped to each other, the slice group #2 in the RA #1 and the slice group #1 in the RA #2 may be mapped to each other, and two mapping relationships may be included in one piece of mapping information. In the example illustrated in FIG. 15, the slice group #1 in the RA #1 and the slice group #2 in the RA #2 may be mapped to each other, the slice group #2 in the RA #1 and the slice group #1 in the RA #2 may be mapped to each other, the slice group #3 in the RA #1 and the slice group #3 in the RA #2 may be mapped to each other, and three mapping relationships may be included in one piece of mapping information. Note that the mapping information may include information indicating the type of each mapping relationship (a “partial match” or a “complete match”). The mapping information may include information indicating the number of network slices included in each slice group.

In the examples described above, the network slices included in the slice group vary from RA to RA, but the present invention is not limited to this. For example, the network slices included in the slice group may vary from TA to TA. For example, in FIG. 15, by replacing the portion labeled “RA #1” with “TA #1” and replacing the portion labeled “RA #2” with “TA #2”, the present embodiment can be implemented as is the case with the RAs.

That is, any region may be used as long as the mapping relationships between the slice groups and the network slices are homogeneous in the regions. When the mapping relationships between the slice groups and the network slices may change between such regions, the present embodiment can be implemented at the boundary between such regions. The above-described examples indicate that the region may be either an RA or a TA. The region may be a RAN-based Notification Area (RNA) or may be a Public Land Mobile Network (PLMN). The region may include a plurality of cells. The region may include a plurality of RAs, may include a plurality of TAs, or may include a plurality of RNAs. The region may be a combination of a TA, an RA, an RNA, a PLMN, and a plurality of cells. For example, the gNB 200 arranged in the TA #1 may transmit the mapping information of the RA #2 adjacent to TA #1.

Operation Example according to First Embodiment

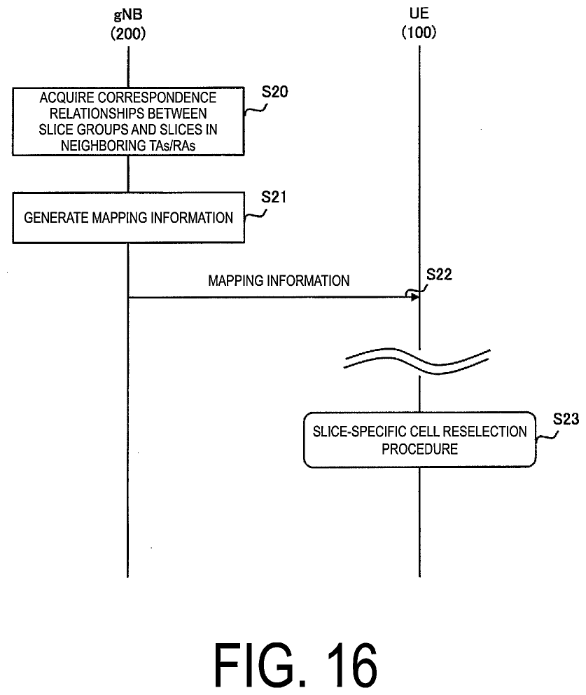

FIG. 16 is a flowchart illustrating an operation example according to the first embodiment. In the following description, the regions are RAs (or TAs) as an example.

As illustrated in FIG. 16, in step S20, the gNB 200 acquires the mapping relationships between the slice groups and the network slices in the neighboring RA (or the neighboring TA). The gNB 200-1 may acquire the information representing the mapping relationships between the slice groups and the network slices from the neighboring gNB 200-2 arranged in the neighboring RA (or the neighboring TA). In this case, the gNB 200-1 may acquire the information by receiving an Xn message including the information. The gNB 200-1 may acquire the information by receiving, from the AMF 300, an NG message including the information.

In step S21, the gNB 200 generates mapping information based on the mapping relationships between the slice groups and the network slices in the local RA (or the local TA) and the mapping relationships between the slice groups and the network slices in the neighboring RA (or the neighboring TA). In the example of FIG. 13, the gNB 200 manages the mapping relationship between the slice group #1 and the slices (the slice #1 and the slice #2) in the local RA (the RA #1). The gNB 200 is assumed to have acquired, from the neighboring RA, the mapping relationships between the slice groups and the network slices (the mapping relationship between the slice group #1 and the slices (the slice #3 and the slice #4) and the mapping relationship between the slice group #2 and the slices (the slice #1 and the slice #5)). In this case, since the slice group #1 in the RA #1 and the slice group #2 in the RA #2 both include the slice #1, the gNB 200 generates mapping information in which the slice group #1 in the RA #1 and the slice group #2 in the RA #2 are mapped to each other.

Note that the gNB 200 may acquire the mapping information from the AMF 300, while generating no mapping information by itself. In this case, the gNB 200 may acquire the mapping information by receiving the NG message including the mapping information. The gNB 200 may acquire the mapping information from the neighboring gNB, while generating no mapping information by itself. In this case, the gNB 200 may acquire the mapping information by receiving the Xn message including the mapping information.

Referring back to FIG. 16, in Step S22, the gNB 200 transmits the mapping information. The gNB 200 may broadcast the mapping information through broadcast signaling (e.g., the SIB). The gNB 200 may transmit the mapping information through dedicated signaling (e.g., RRC release (RRCRelease) message). In this case, the gNB 200 may include, in the mapping information, the mapping relationships between the slice groups and the network slices in the neighboring RA (or the neighboring TA). For example, in the example of FIG. 13, the gNB 200-1 may transmit mapping information including the mapping relationship between the slice group #1 and the slices (the slice #3 and the slice #4) in the RA #2 and the mapping relationship between the slice group #2 and the slices (the slice #1 and the slice #5) in the RA #2. This is because concern about security is mitigated in the RRC message. However, regardless of the RRC message, even in the case of broadcast transmission, the gNB 200 may transmit, in a predetermined case, the mapping relationships between the slice groups and the network slices in the neighboring RA (or neighboring TA). The predetermined case is, for example, the case of only a “partial match” with the neighboring RA (or the neighboring TA) and/or the case of the boundary between the RAs (or the TAs). This is based on the idea that the concern for security is not regarded as a problem under a limited condition involving the predetermined case.

Note that the mapping information may include a Tracking Area Code (TAC) and/or a Physical Cell ID (PCI).

Note that the AMF 300 may transmit the mapping information to the UE 100. In this case, the AMF 300 may transmit, to the NAS of the UE 100, a NAS message including the mapping information, and the NAS of the UE 100 may notify the AS of the UE 100 of the mapping information. In this case, upon generating mapping information, the gNB 200 may transmit, to the AMF 300, the NG message including the mapping information.

Subsequently, in step S23, the UE 100 performs the slice-specific cell reselection procedure using the mapping information. For example, as illustrated in FIG. 13, a case is considered in which the UE 100 moves to the vicinity of the cell of the gNB 200-2 arranged in the neighboring RA (or the neighboring TA) and performs the slice-specific cell reselection procedure. Even in this case, the UE 100 can select the slice group #2 in the RA #2 as a selected slice using the mapping information, and can reselect the cell supporting the slice group #2 in the RA #2.

Note that the transmission of the mapping information (step S22) and the execution of the slice-specific cell reselection procedure (step S23) may be performed at predetermined timings. For example, at the stage where the field strength of the serving cell in the UE 100 (e.g., the serving cell of the gNB 200-1) does not require cell reselection, the gNB 200 transmits the mapping information (step S22). Then, at the stage where the field strength requires cell reselection, the UE 100 may perform the slice-specific cell reselection procedure (step S23).

### OTHER EMBODIMENTS

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variations can be made without departing from the gist of the present disclosure. All or some of the embodiments, operations, processes, and steps may be combined without being inconsistent.

### Supplementary Note

Features relating to the embodiments described above are described below as supplements.

(1)

A cell reselection method in a mobile communication system, the cell reselection method including:
transmitting, by a base station, mapping information between a first slice group and a second slice group when the second slice group includes at least some of network slices included in the first slice group, the first slice group being available in a region of the base station, and the second slice group being available in a neighboring region adjacent to the region; and
performing, by a user equipment, slice-specific cell reselection by using the mapping information.
   (2)

The cell reselection method according to (1) recited above, wherein the region is a Tracking Area (TA), and the neighboring region is a neighboring TA adjacent to the TA, or
the region is a Registration Area (RA), and the neighboring region is a neighboring RA adjacent to the RA.
   (3)

The cell reselection method according to (1) or (2) recited above, wherein
the mapping information includes identification information of the first slice group and
identification information of the second slice group.

### REFERENCE SIGNS

1: Mobile communication system
20: 5GC
100: UE
110: Receiver
120: Transmitter
130: Controller
200: gNB
210: Transmitter
220: Receiver
230: Controller
300: AMF

1. A cell reselection method in a mobile communication system, the cell reselection method comprising:
transmitting, by a base station, mapping information between a first slice group and a second slice group when the second slice group comprises at least some of network slices comprised in the first slice group, the first slice group being available in a region of the base station, and the second slice group being available in a neighboring region adjacent to the region; and
performing, by a user equipment, slice-specific cell reselection by using the mapping information.

2. The cell reselection method according to claim 1, wherein
the region is a Tracking Area (TA), and the neighboring region is a neighboring TA adjacent to the TA, or
the region is a Registration Area (RA), and the neighboring region is a neighboring RA adjacent to the RA.

3. The cell reselection method according to claim 1, wherein
the mapping information comprises identification information of the first slice group and identification information of the second slice group.

4. A user equipment comprising:
a receiver configured to receive from a base station, mapping information between a first slice group and a second slice group when the second slice group comprises at least some of network slices comprised in the first slice group, the first slice group being available in a region of the base station, and the second slice group being available in a neighboring region adjacent to the region, and
a controller configured to perform slice-specific cell reselection by using the mapping information.
